(19) United States
(12) Patent Application Publication
(10) Pub. No.: US 2015/0025930 A1
(43) Pub. Date: Jan. 22, 2015

(54) METHOD AND APPARATUS FOR RECOMMENDING POSITION OF INTEREST

(71) Applicant: Samsung Electronics Co., Ltd., Suwon-si (KR)

(72) Inventors: Jong-eun YANG, Seoul (KR); Jung-yeon YANG, Suwon-si (KR); Jeong-soo LEE, Suwon-si (KR); Young-hoon KIM, Seongnam-si (KR); Young-hee PARK, Seoul (KR)

(73) Assignee: Samsung Electronics Co., Ltd., Suwon-si (KR)

(21) Appl. No.: 14/337,618

(22) Filed: Jul. 22, 2014

(30) Foreign Application Priority Data
Jul. 22, 2013 (KR) 10-2013-0086273

(51) Int. Cl. G06Q 10/10

(52) U.S. Cl. CPC G06Q 10/1093
USPC 705/7.18

(57) ABSTRACT

A method, performed by a device, of receiving a recommendation of a position from a position-recommendation apparatus, a device for receiving a recommendation from a position-recommendation apparatus, and a position-recommendation apparatus for recommending a position to a device are provided. The method includes obtaining a selected time, for which a position is to be recommended, from a user, transmitting a position-recommendation request, which includes schedule event information relating to the selected time, to the position-recommendation apparatus, and receiving a response to the position-recommendation request, which includes one or more positions that are searched for based on the schedule event information, from the position-recommendation apparatus.

### CROSS-REFERENCE TO RELATED APPLICATIONS

This application is related to, and claims priority to Korean Patent Application No. 10-2013-0086273, filed on Jul. 22, 2013, in the Korean Intellectual Property Office, the disclosure of which is incorporated herein in its entirety by reference.

### BACKGROUND

1. Field

Exemplary embodiments of the present invention relate to a method and an apparatus for recommending a position to a user, and more particularly, to a method and an apparatus for recommending a position to a user by analyzing a schedule event or to-do information.

2. Description of the Related Art

A position, in which a user may be interested, may be recommended to the user by using technologies for recommending a position near the user to the user by using a global positioning system (GPS) of the user, or recommending a position to the user by extracting a frequently-visited position from a user log such as the web or a social network service (SNS).

Since such technologies may not take a plan or an intention of the user into account, the technologies may not recommend an appropriate position in a particular future situation.

### SUMMARY

Exemplary embodiments of the present invention include a method and an apparatus for recommending a position that is appropriate for a user's schedule or to-do list by analyzing a schedule event or to-do information of the user.

Additional aspects will be set forth in part in the description which follows and, in part, will be apparent from the description, or may be learned by practice of the presented embodiments.

According to an exemplary embodiment of the present invention, a method, performed by a device, of receiving a recommendation of a position from a position-recommendation apparatus includes obtaining a selected time, for which a position is to be recommended, from a user, transmitting a position-recommendation request, which includes schedule event information relating to the selected time, to the position-recommendation apparatus, and receiving a response to the position-recommendation request, which includes one or more positions that are searched for based on the schedule event information, from the position-recommendation apparatus.

According to an exemplary embodiment of the present invention, a method, performed by a position-recommendation apparatus, of recommending a position to a device includes receiving a position-recommendation request, which includes schedule event information relating to a selected time for which a position is to be recommended to a user, from the device, searching for one or more positions based on the schedule event information, and transmitting a response to the position-recommendation request, which includes one or more found positions, to the device.

According to an exemplary embodiment of the present invention, a device for receiving a recommendation from a position-recommendation apparatus includes an input unit for receiving an input of a selected time for which a position is to be recommended, a basic information extraction unit for extracting basic information for position recommendation from schedule event information relating to the selected time, and a communication unit for transmitting a position-recommendation request, which includes the extracted basic information for position recommendation, to the position-recommendation apparatus, and receiving a response to the position-recommendation request, which includes one or more positions that are searched for based on the basic information for position recommendation, from the position-recommendation apparatus.

According to an exemplary embodiment of the present invention, a position-recommendation apparatus for recommending a position to a device includes, a schedule information receiving unit for receiving a position-recommendation request, which includes schedule information relating to a selected time for which a position is to be recommended, from the device; a basic information extraction unit for extracting basic information for position recommendation from the schedule event information, a position searching unit for searching for one or more positions based on the basic information for position recommendation, and a position transmitting unit for transmitting a response to the position-recommendation request, which includes that searched for position, to the device.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an exemplary system for recommending a position based on schedule event information or to-do information, according to an embodiment of the present invention;

FIG. 2 illustrates an exemplary screen for, if a user selects a pre-stored schedule, providing a position relating to the selected schedule;

FIG. 3 illustrates an exemplary method, performed by a device, of recommending a relevant position to a user based on schedule event information or to-do information of the user;

FIG. 4 illustrates exemplary extracting of basic information for position recommendation from schedule event information or to-do information, according to an embodiment of the present invention;

FIG. 5 illustrates an exemplary method in which, if a user selects one of schedule events, a position is recommended based on the selected schedule event, according to an embodiment of the present invention;

FIG. 6 illustrates an exemplary method in which, if a user selects a blank schedule event, a position which is appropriate for the blank schedule event is recommended, according to an embodiment of the present invention;

FIG. 7A-7C illustrate an exemplary method in which, if a user selects a time at which a schedule event is blank, an activity that is appropriate for the selected time is derived from a schedule event before or after the selected time and a position is recommended based on the derived activity, according to an embodiment of the present invention;

FIG. 8 illustrates an exemplary a method in which, if a user selects a time at which a schedule event is blank, a position is recommended based on a schedule pattern and a relationship between the schedule pattern and a position, according to an embodiment of the present invention;

FIGS. 9A and 9B illustrate an example in which, if a user selects a time at which a schedule event is blank, a to-do that is appropriate for the selected time is selected from a schedule event before or after the selected time and to-do information that is stored in the device, and a position is recommended based on the selected to-do, according to an embodiment of the present invention;

FIG. 10 illustrates an exemplary method in which, if a schedule event is selected, the device receives a recommendation of a position regarding the selected schedule event or to-do information;

FIG. 11 illustrates an exemplary a method, performed by the device, of recommending a position, according to whether a schedule event is present at a time that a user selects;

FIG. 12 illustrates an exemplary a method of a position recommendation apparatus, recommending a position to a device and receiving information about a position that is selected by the device, thus updating a database (DB);

FIG. 13 illustrates an exemplary system for recommending a position based on schedule event information or to-do information, according to an embodiment of the present invention; and

FIG. 14 illustrates a device and a position recommendation apparatus for recommending a position based on schedule event information or to-do information, according to an embodiment of the present invention.

### DETAILED DESCRIPTION

Reference will now be made in detail to embodiments, examples of which are illustrated in the accompanying drawings, wherein like reference numerals refer to like elements throughout. Exemplary embodiments may have different forms and should not be construed as being limited to the descriptions set forth herein. As used herein, the term “and/or” includes any and all combinations of one or more of the associated listed items.

General and widely-used terms are disclosed herein, in consideration of functions provided in embodiments of the present invention, and may vary according to an intention of one of ordinary skill in the art, a precedent, or emergence of new technologies. Accordingly, It will be understood that the terms, used herein, should be interpreted as having a meaning that is consistent with their meaning in the context of the relevant art and will not be interpreted in an idealized or overly formal sense unless expressly so defined herein.

It will be further understood that the terms “comprises”, “comprising”, “includes”, and/or “including” when used herein, specify the presence of components, but do not preclude the presence or addition of one or more other components, unless otherwise specified. Additionally, terms used herein, such as “unit” or “module” refer to entities for processing at least one function or operation. These entities may be implemented by hardware, software, or a combination of hardware and software.

“Schedule event information”, described herein, refers to information regarding work of which a particular execution time is determined, from among work that a user is to do, and “to-do information” refers to information regarding work that a user wants to do but a particular execution time is not specified. According to an exemplary embodiment of the present invention, a form of schedule event information or to-do information includes all types of information that may be recognized by a computer, as well as an application or a web application for a schedule or a to-do list.

Schedule event information and/or to-do information may be stored in a device and/or in a position-recommendation apparatus. Schedule event information and/or to-do information may be stored in an external device, an external server, or a cloud server that may interwork with the device or the position-recommendation apparatus.

Schedule event information and/or to-do information may be stored in the form of a sentence or a phrase, or stored as a particular item, that is, a position, a time, a relationship between a particular person and a user, or an activity. A particular item of a schedule event and/or a to-do may be stored in a mark-up language such as extensible mark-up language (XML).

According to an embodiment of the present invention, a point of interest (POI) refers to a particular position or a particular location that is useful to a user or a user is interested in.

According to an embodiment of the present invention, if a schedule event and/or a to-do is selected, a position relating to the selected schedule event may be recommended. According to an embodiment of the present invention, if a user selects a time at which a schedule event is not present, a position may be recommended based on a schedule event before or after the selected time. According to an embodiment of the present invention, if a user selects a time at which a schedule event is not present, a position may be recommended by referring to a schedule event before or after the selected time and to-do information of a user.

The present invention is described fully with reference to the accompanying drawings, in which exemplary embodiments of the invention are illustrated. The invention may, however, be embodied in many different forms and should not be construed as being limited to the embodiments set forth herein. Like numbers refer to like elements throughout the description of the figures.

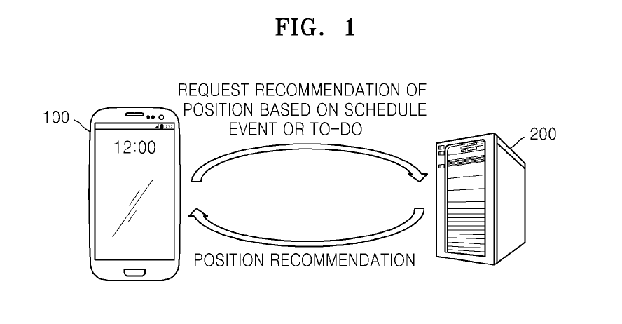

FIG. 1 illustrates an exemplary system for recommending a position based on schedule event information and/or to-do information, according to an embodiment of the present invention.

As illustrated in FIG. 1, the position-recommendation system may include a device 100 and a position-recommendation apparatus 200, according to an embodiment of the present invention.

The device 100 may recommend a position relating to a user's schedule or to-do list to the user. In other words, the device 100 may request recommendation of a position from the position-recommendation apparatus 200 based on schedule event information or to-do information of a user. The device 100 may receive a position, which is appropriate for a time that is selected by the user, from the position-recommendation apparatus 200, and provide the received position to the user.

The device 100 may provide a recommended position, which is appropriate for a time at which a schedule event is not present, to a user by using a schedule event before or after the time or to-do information.

The device 100 may be an apparatus for recommending a position to a user by using schedule event information or to-do information of a user. For example, the device 100 may be a cellular phone, a smartphone, a laptop computer, a tablet personal computer (PC), an electronic book terminal, a digital broadcasting terminal, a personal digital assistant (PDA), a portable multimedia player (PMP), a moving pictures expert group audio layer 3 (MP3) player, a digital camera, or a navigation device. The device 100 may include a communication interface so as to execute a wired and/or wireless communication with the position-recommendation apparatus 200.

The position-recommendation apparatus 200 may receive schedule event information or to-do information from the device 100 and, based on the received schedule event information or the to-do information, search for a position. The position-recommendation apparatus 200 may transmit a found position to the device 100.

The position-recommendation apparatus 200 may transmit a position, which is appropriate for a time at which a schedule event is not present, to the device 100 by using a schedule event before or after the time. The position-recommendation apparatus 200 may transmit a position, which is appropriate for a time at which a schedule event is not present, to the device 100 by using to-do information.

The position-recommendation apparatus 200 may be a set of a plurality of devices, or a device that may function as the position-recommendation apparatus 200. However, the position-recommendation apparatus 200 is not limited thereto.

The position-recommendation apparatus 200 may include a database for storing a position and/or may search an external position database via a wired and/or wireless communication, and thus provide a position.

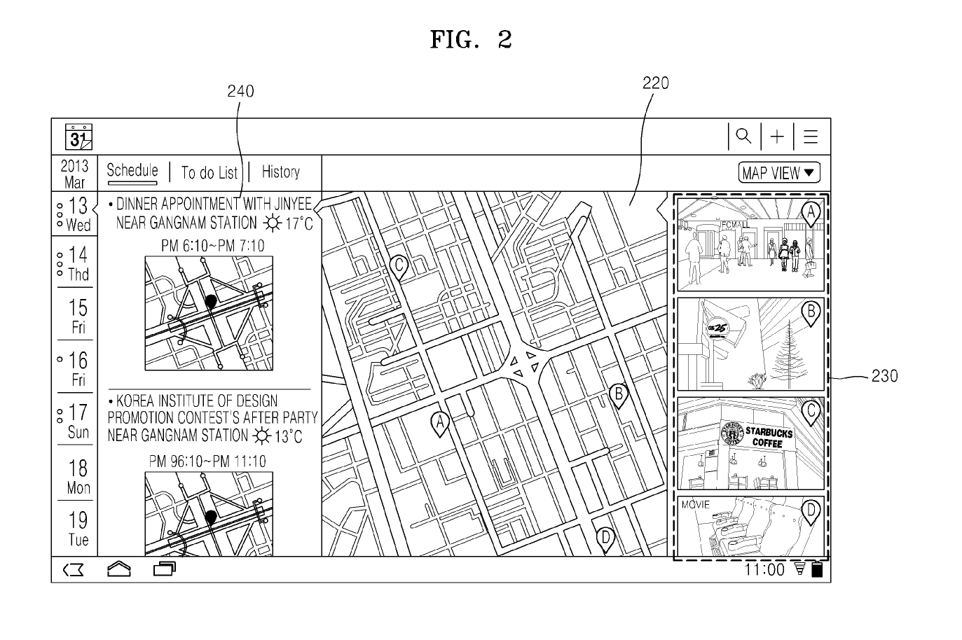

FIG. 2 illustrates an exemplary screen for, if a user selects a schedule event from among pre-stored schedule events, providing a position relating to the selected schedule event.

If a user selects one schedule event 240 from among schedule events, a position that is received from the position-recommendation apparatus 200 may be displayed as a map 220 or position-related information 230. A position-recommendation application, which provides a position to a user, may provide a date, a time, a schedule event description, a to-do list, a map for the schedule event, and/or a recommended position. The position-recommendation application may recommend a position for a time at which a schedule event is not present, or a position regarding to-do information of a user.

The position-related information 230 may be received in the form of metadata from the position-recommendation apparatus 200. The position-related information 230 may include map information, a location, a distance between a user and a target position, a uniform resource locator (URL) for introducing the position, or the like.

Referring to FIG. 2, the map 220 illustrates positions that are recommended based on a position for a schedule event that is selected by a user. The position-related information 230 shows information about positions, which is displayed by using the received metadata. If a user selects one of the recommended positions, the selected position may be stored as a position for a corresponding schedule event.

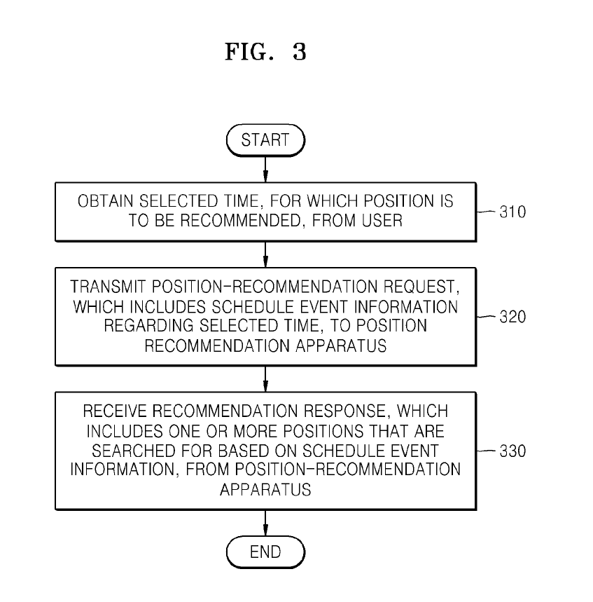

FIG. 3 illustrates an exemplary method, performed by a device 100, of recommending a relevant position to a user based on schedule event information or to-do information of the user.

In operation S310, the device 100 obtains a selected time, for which a position is to be recommended, from a user. In other words, the device 100 obtains a time from a schedule event that is selected by the user. If the user selects a schedule event that is stored in a schedule application, the device 100 may obtain a time corresponding to the selected schedule event. If a user selects a blank schedule event, a time corresponding to the blank schedule event may be obtained. The device 100 may obtain a selected time by inferring an intention of the user from additional user information.

In operation S320, the device 100 transmits a position-recommendation request, which includes schedule event information regarding the selected time, to the position recommendation apparatus 200.

A schedule event regarding the selected time refers to, if a schedule event is present at the selected time, the corresponding schedule event or, if a schedule event is not present at the selected time, a schedule event before or after the selected time.

The schedule event before, or after, the selected time may be a schedule event before the selected time with a preset time period or a schedule event after the selected time with a preset time period. The schedule event before, or after, the selected time with a preset time period may be right before or after the selected time, or several hours before or after the selected time. The schedule event before, or after, the selected time with a preset time period may be several days before or after the selected time. However, the schedule event before, or after, the selected time with a preset time period is not limited thereto.

The schedule event information, transmitted to the position-recommendation apparatus 200, may be schedule event information that is stored in the device 100. For example, if a user selects one schedule event, the device 100 may transmit stored schedule event information to the position-recommendation apparatus 200.

The schedule event information, transmitted to the position-recommendation apparatus 200, may be basic information for position recommendation, which is extracted from the stored schedule event information. For example, if a user selects one schedule event, basic information for position recommendation, such as a position in the schedule event, a relationship between a particular person and a user, or an activity, may be extracted from the selected schedule event. The basic information for position recommendation may be transmitted to the position-recommendation apparatus 200.

The extracting of basic information for position recommendation may be divided and performed by the device 100 and the position-recommendation apparatus 200, and is not limited to one apparatus.

As an example illustrated in FIG. 2, if a user selects the schedule event 240 of “Dinner appointment with Jinyee”, basic information for position recommendation that includes “Gangnam station” as a position, “May 13” as a date, “6:10 pm to 7:10 pm” as a time, a friend as a relationship between a particular person and a user, dinner as an activity, and a social gathering as an object of the schedule event, for example, may be extracted from the selected schedule event.

In operation S330, a recommendation response, which includes one or more positions that are searched for based on the schedule event information, is received. In other words, one or more positions, which are searched for based on basic information for position recommendation such as a position, a time, a date, an activity, a relationship between a particular person and a user, a day of a week, an anniversary day, or an object, may be received from the position-recommendation apparatus 200.

For example, if a position is recommended based on a position for the selected schedule event, a position that is adjacent to the position for the selected schedule event may be recommended.

For example, when a position is recommended based on an object of the selected schedule event, if an object of the selected schedule event is to have a meal, a restaurant, a cafe, or a bar may be received. If an object of the selected schedule event is a business trip, a hotel, a gift shop, or a duty-free shop may be received. If an object of the selected schedule event is shopping, a shopping mall or a famous shop may be received. As such, a position that is appropriate for a spare time or a trip time may be recommended, according to an object of the schedule event.

For example, when a position is recommended based on a relationship between a particular person and a user, if the relationship is family, a family restaurant may be received. If the relationship is a friend, a bar may be recommended.

A position may be recommended based on a plurality of pieces of basic information for position recommendation.

A position may be recommended based on statistical information about position selection made by users. Statistical information about position selection refers to statistical information about a position that is favored by users according to classification of users such as an age, a gender, or a job. The statistical information about position selection may be databased by receiving information about position selection by users from the device 100.

The statistical information about position selection may be classified and stored according to basic items for position recommendation.

For example, the statistical information about position selection may be classified and stored according to an object of the schedule event. If the users frequently visit a particular position when on a date, the particular position may be databased as a position that is appropriate for a date. If an object of a schedule event is a date, the position-recommendation apparatus 200 may recommend the corresponding position.

For example, the statistical information about position selection may be classified and stored according to days of the week or an anniversary day. For example, if users frequently visit a particular position on Christmas day, the particular position may be databased as an appropriate position for Christmas day. If a date for the schedule event is Christmas day, the position-recommendation apparatus 200 may recommend the corresponding position.

The statistical information about position selection may include information about a relationship between positions. For example, if there are a lot of users who visit a restaurant A, and then, move to a cafe B, the position-recommendation apparatus 200 may recommend the cafe B to a user who is to visit the restaurant A.

The statistical information about position selection may be stored according to a user. The position-recommendation apparatus 200 may recommend a position that has been selected by the user before. The statistical information about position selection may be stored in the device 100 in the form of a log.

According to an embodiment of the present invention, a user's plan or future situation may be taken into account in order to recommend a position, and a position that is appropriate for an object or a situation of the schedule event may be recommended.

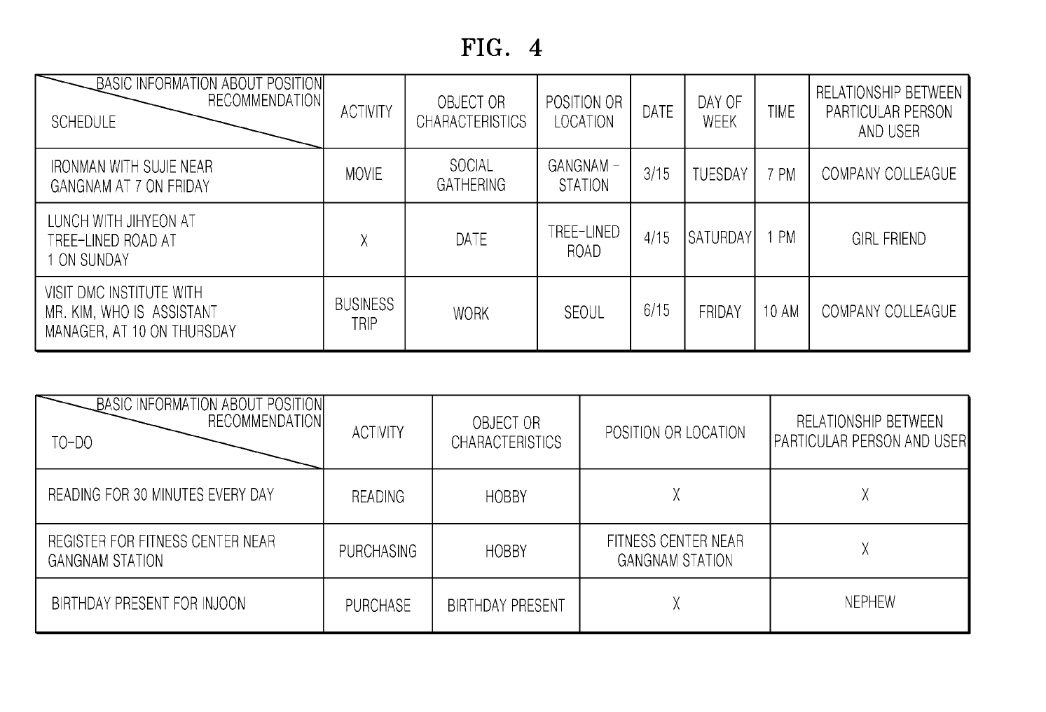

FIG. 4 illustrates exemplary tables illustrating an extracting of basic information for position recommendation from schedule event information and/or to-do information, according to an embodiment of the present invention.

The basic information for position recommendation is information that is a basis for position recommendation, and may be a search keyword for searching for a position.

The basic information for position recommendation may include a position, a time, a date, a relationship between a particular person and a user, a day of a week, an anniversary day, an activity of the schedule event, and/or an object or characteristics of the schedule event.

The basic information for position recommendation may be extracted by analyzing a context of schedule event information or to-do information. In other words, an activity to be executed by a user, a position, a date, a time, a relationship between a particular person and a user, or an object or characteristics of the activity may be extracted by analyzing a situation and an environment in which a schedule event or a to-do is generated.

The basic information for position recommendation may be extracted by using a profile of a user, a contact information of the user, or other information that may show an environment of the user. For example, a person who is included in the schedule event information or to-do information may be inferred from information about a contact information of the user. An object and/or characteristics of an activity may be inferred from a job of the user that is included in the profile of the user.

The basic information for position recommendation may be extracted by using a local information database (DB), a position DB, a content DB, or a dictionary DB. For example, whether a particular word represents a position or content may be inferred by using a position DB or a content DB.

As an example, if it is assumed that schedule event information or to-do information is “Ironman with Sujie in Gangnam at 7 on Friday”, basic information for position recommendation may be presumed by analyzing an exact meaning of respective words. That is, “Friday” may be classified as a day of a week. “Sujie” may be classified as a person by using preposition information that is used before a word “Sujie”, and presumed as a company colleague by referring to contact information of a user. “Ironman” may be presumed as a movie by using a content DB. “At 7” may be classified as time and may be 7 in the morning or evening, but may be presumed as 7 in the evening according to a context of information. “Gangnam” may be classified as Gangnam-district or Gangnam station from a position DB, but may be presumed as Gangnam station according to a context of information. A user may be presumed, for example, to have a plan to see a movie “Ironman” with a company colleague at 7 in the evening. An object or characteristics of the movie may be determined as a social gathering with a company colleague.

According to an exemplary embodiment, schedule event information or to-do information may be stored in the form of a sentence or a phrase. However, even when schedule event information or to-do information is classified and stored as particular items of a schedule event or a to-do, that is, a position, a time, a relationship between a particular person and a user, or an activity, basic information for position recommendation may be determined by using the same method.

A process of extracting basic information for position recommendation may be performed by the device 100 or the position-recommendation apparatus 200. The process may be divided into items and performed by the device 100 or the position-recommendation apparatus 200, for example, according to the respective items.

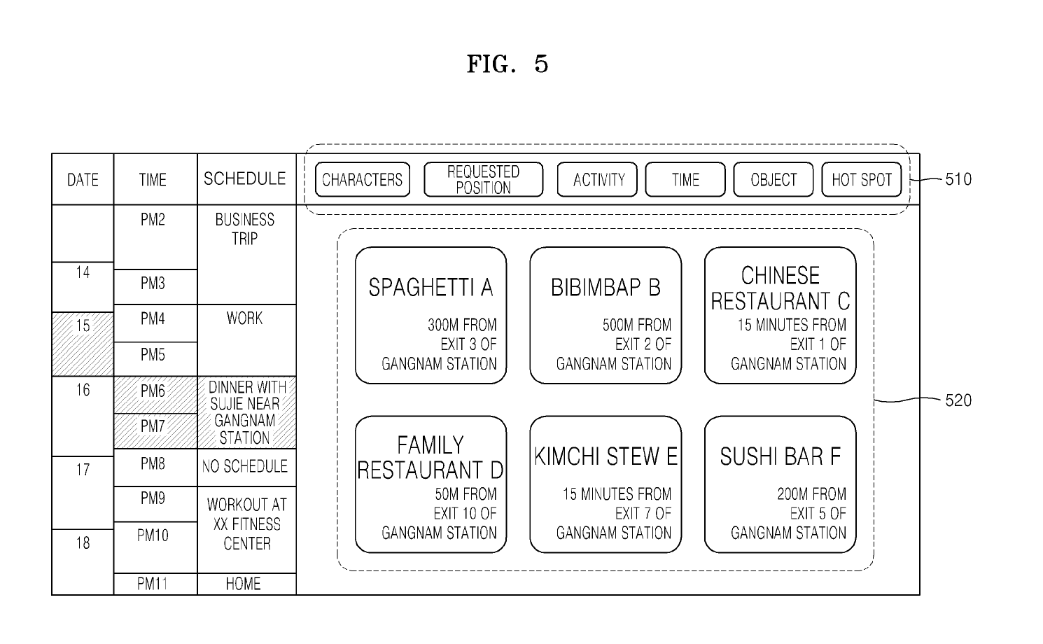

FIG. 5 illustrates an exemplary method in which, if a user selects one of schedule events, a position is recommended based on the selected schedule event according to an embodiment of the present invention.

Referring to FIG. 5, a user selected “Dinner with Sujie near Gangnam Station” from among schedule events. The selected time is from 6 pm to 8 pm on the 15th. Basic information for position recommendation with regard to the selected schedule event, such as “Gangnam Station” as a position, “evening” as time, “friend” as a relationship between a particular person and a user, “a social gathering” as an object, and “dinner” as an activity, may be extracted.

The position-recommendation apparatus 200 searches for a position relating to the schedule event based on the basic information for position recommendation, which includes 6 pm to 8 pm as the selected time, Gangnam station as a position, evening as time, a friend as a relationship between a particular person and a user, a social gathering as an object, and dinner as an activity. The position-recommendation apparatus 200 transmits a found position to the device 100.

The position-recommendation apparatus 200 may recommend a position in consideration of a spare time or a trip time between schedule events before or after the selected time. For example, when a position for “Dinner with Sujie near Gangnam Station” is recommended, a schedule event before the selected time is work, and a schedule event after the selected time is not present, Thus, a position for activity that may take a long time may be recommended.

With regard to the embodiment illustrated in FIG. 5, a position, in which a user is to eat dinner near Gangnam station with a friend, is recommended.

A screen 510 illustrates basic information items for position recommendation, which are to be considered first for position recommendation. A user may select an item that is to be considered first for position recommendation, from among basic information for position recommendation. If a user selects an item that is to be considered first, a position is searched for based on the selected item.

A screen 520 illustrates an example in which a received position is displayed on a screen, and thus provided to a user.

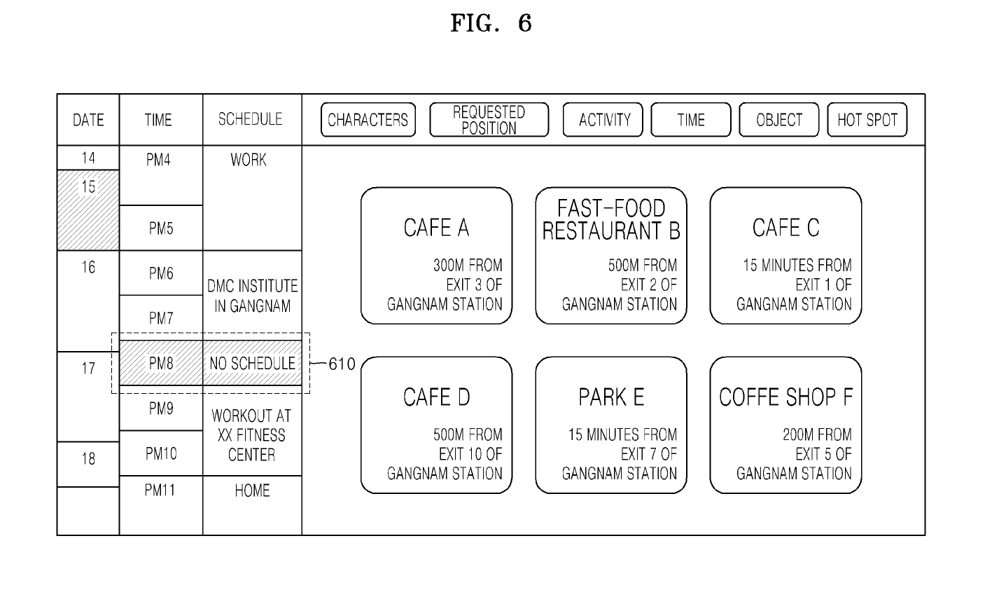

FIG. 6 illustrates a method in which, if a user selects a blank schedule event, a position which is appropriate for the blank schedule event is recommended, according to an embodiment of the present invention.

According to an embodiment of the present invention, if a user selects a blank schedule event, basic information for position recommendation may be extracted from a schedule event before or after the blank schedule event, and thus, a position appropriate for the selected time may be recommended.

If a user selects a blank schedule event, a position relating to a schedule event before or after the blank schedule event may be recommended. A common point between basic information for position recommendation about a schedule event before the blank schedule event and basic information for position recommendation about a schedule event after the blank schedule event may be extracted, and thus a position relating to the common point may be recommended.

For example, with regard to the schedule illustrated in FIG. 6, if a user selects a blank schedule event 610, which is a “No schedule” event, so as to receive a position recommendation for a blank schedule event, basic information about position recommendation may be extracted from a schedule event before or after 8 pm. Work in Gangnam at 7 pm may be extracted as basic information for position recommendation from the “DMC institute in Gangnam” that is a schedule event before the selected time. A hobby, a workout, Gangnam, and 9 pm may be extracted as basic information for position recommendation from “xx fitness center in Gangnam” that is a schedule event after the selected time. Accordingly, common basic information for position recommendation between schedule events before and after the selected time is Gangnam as a position. Thus, a user is presumed to be in Gangnam before and after the schedule event. Resultantly, a recommended position may be a position that is appropriate for Gangnam at 8 pm.

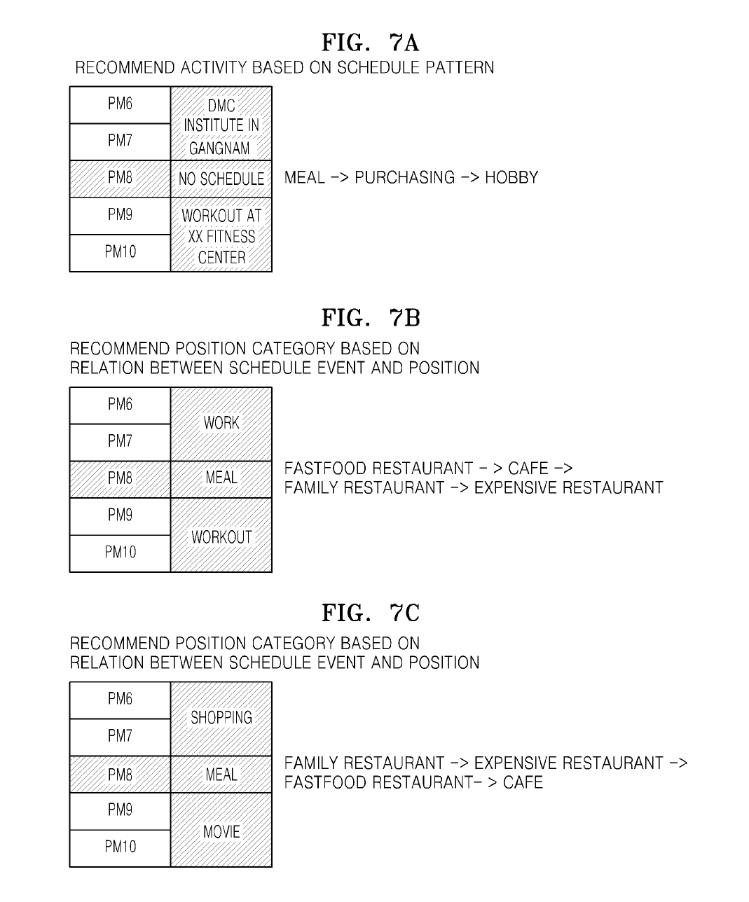

FIG. 7A through 7C illustrate an exemplary method in which, if a user selects a time at which a schedule event is blank, an activity that is appropriate for the selected time may be derived from a schedule event before or after the selected time. A position may be recommended based on the derived activity, according to an embodiment of the present invention.

If a schedule event is not present at the selected time, an activity that is appropriate for the selected time may be selected based on a schedule event before or after the selected time. In detail, an activity that is appropriate for the selected time may be extracted from a schedule pattern DB, based on an object, characteristics, or an activity of a schedule event before or after the selected time.

The schedule pattern DB may be obtained by databasing a pattern for a schedule of a particular user or all users based on statistics. An activity, which has a high possibility of being executed at the selected time, may be extracted by using the schedule pattern DB, based on an object, characteristics, or an activity of a schedule event before or after the time that is selected by a user.

For example, with regard to a schedule illustrated in FIG. 7A, an activity of a schedule event before the selected time is work, and an activity of a schedule event after the selected time is a workout. When schedule events before and after the selected time are work and a workout, if activities which have a high possibility of being executed at the selected time are extracted from the schedule pattern DB in an order of a dinner, a purchase, and a hobby, activities that are appropriate for the selected time may be determined in an order of a dinner, a purchase, and a hobby. Accordingly, Gangnam station as a position, 8 pm as time, and dinner as an activity may be recommended based on schedule events before and after the selected time and a dinner as an activity appropriate for the selected time.

According to an embodiment of the present invention, a position, to be recommended for a time at which a schedule event is not present, may be recommended based on a category for a position that is appropriate for a schedule pattern, in addition to being based on schedule events before and after the selected time and an activity that is appropriate for the selected time, which is extracted from the schedule pattern DB. A position category that is appropriate for a schedule pattern may be extracted from a schedule pattern-position relation DB.

The schedule pattern-position relation DB may be defined as a DB that is obtained by classifying a category for a position that is appropriate for a schedule pattern. Characteristics and an object of a schedule event may be deduced from the schedule pattern. Even if an activity is the same, an appropriate position may vary with the characteristics and the object of the schedule event. For example, if a position for a dinner is recommended, a position appropriate for a dinner may vary according to whether an object of a schedule event before and after the selected time is daily life, a trip, or business.

For example, referring to the schedules illustrated in FIGS. 7B and 7C, an activity that is recommended for a blank schedule event is a meal. Accordingly, a position relating to a meal may be appropriate to be recommended for both the schedules that are illustrated in FIGS. 7B and 7C. However, activities of the schedule event before and after the selected time, illustrated in FIG. 7B, are “Work” and “Workout”. However, activities of the schedule events before and after the selected time, illustrated in FIG. 7C, are “Shopping” and “Movie”. In the case of the schedule illustrated in FIG. 7B, considering that a schedule event before and after the selected time is a workout and performed only by a user, it may be appropriate to recommend a fast-food restaurant or a cafe. However, in the case of the schedule illustrated in FIG. 7C, considering that a schedule event before and after the selected time is for a spare time and it may be highly possible that the user has a companion, it may be appropriate to recommend a family restaurant or an expensive restaurant. Accordingly, a position appropriate for a particular schedule pattern may be recommended by databasing the relationship between a schedule pattern and a position.

According to an embodiment of the present invention, the schedule pattern DB and the schedule pattern-position relation DB may be modeled based on statistics and analysis before being generated as a database. The schedule pattern DB and the schedule pattern-position relation DB may be updated based on the modeled pattern or relationship so as to reflect a position selection that is made by a user.

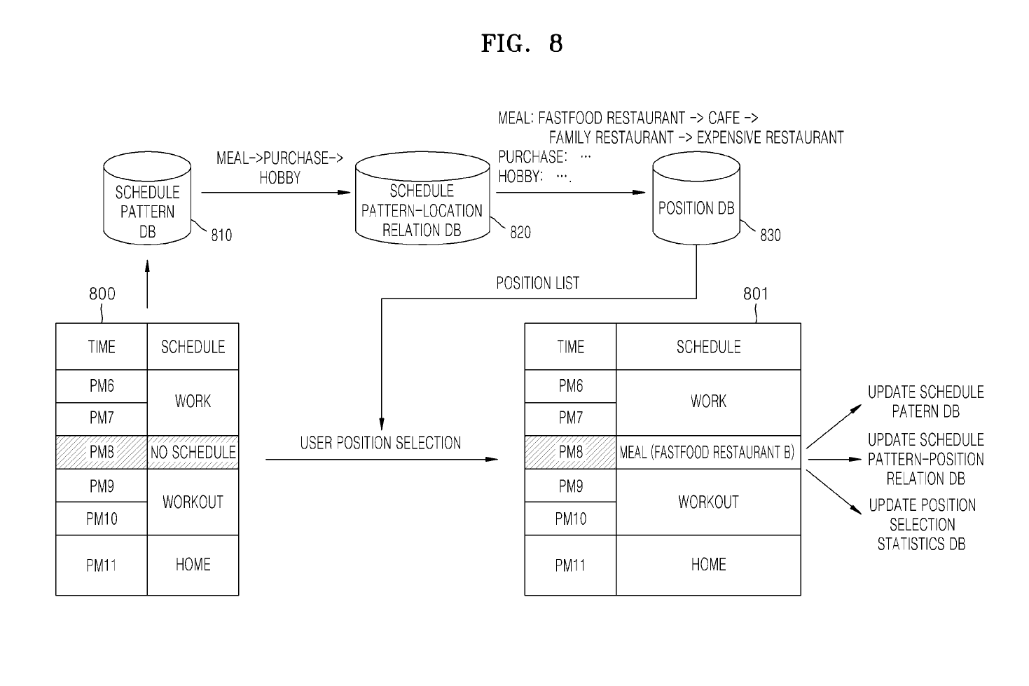

FIG. 8 illustrates a method in which, if a user selects a time at which a schedule event is blank, a position is recommended based on a schedule pattern and a relationship between the schedule pattern and a position, according to an embodiment of the present invention.

If a user selects a blank schedule in a schedule 800 illustrated in FIG. 8, an activity of a schedule event before 8 pm that corresponds to the selected time is work, and an activity of a schedule event after 8 pm is a workout.

If schedule events before and after the selected time are work and a workout, an activity that is appropriate for the selected time may be extracted from a schedule pattern DB 810 in an order of a dinner, a purchase, and a hobby.

If a position for a dinner, from among activities that are appropriate for the selected time, is recommended, a dinner category, which corresponds to the schedule pattern, may be extracted from a schedule pattern-position relation DB 820, and thus, used for position recommendation. In an example illustrated in FIG. 8, since the schedule pattern includes work, a dinner, and a workout, a dinner category may be recommended in an order of a fast-food restaurant, a cafe, a family restaurant, and an expensive restaurant.

Accordingly, a position relating to a fast-food restaurant or a cafe may be extracted from a position DB 830 and recommended to a user.

If the user selects one of the recommended positions, the position-recommendation apparatus 200 may update a position-selection statistics DB, the schedule pattern DB 810, and the schedule pattern-position relation DB 820 by using the selected position.

For example, if the user selects fast-food B as in the schedule 801, a schedule pattern for work, a meal, and a workout may be updated in the schedule pattern DB. In correspondence with a case in which the schedule pattern includes work, a meal, and a workout, fast-food may be updated as a meal category in the schedule pattern-position relation DB. A preference of the fast-food B may be updated in the position-selection statistics DB.

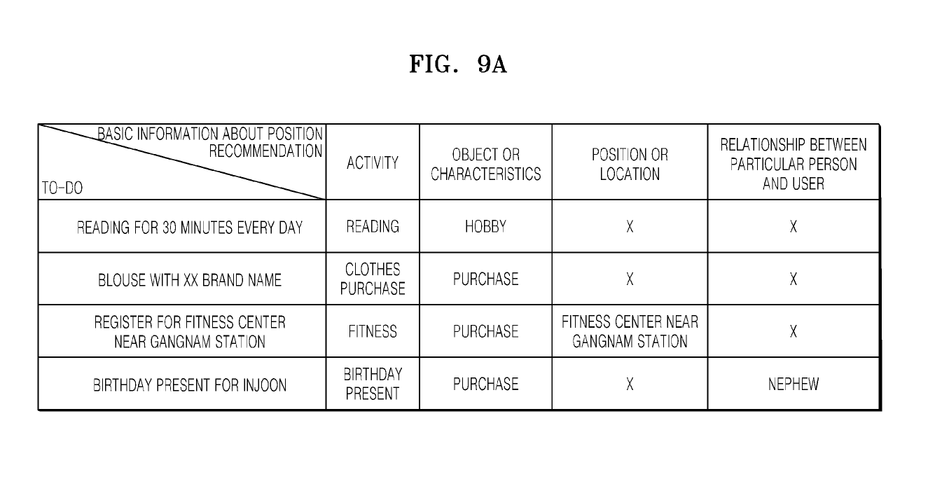

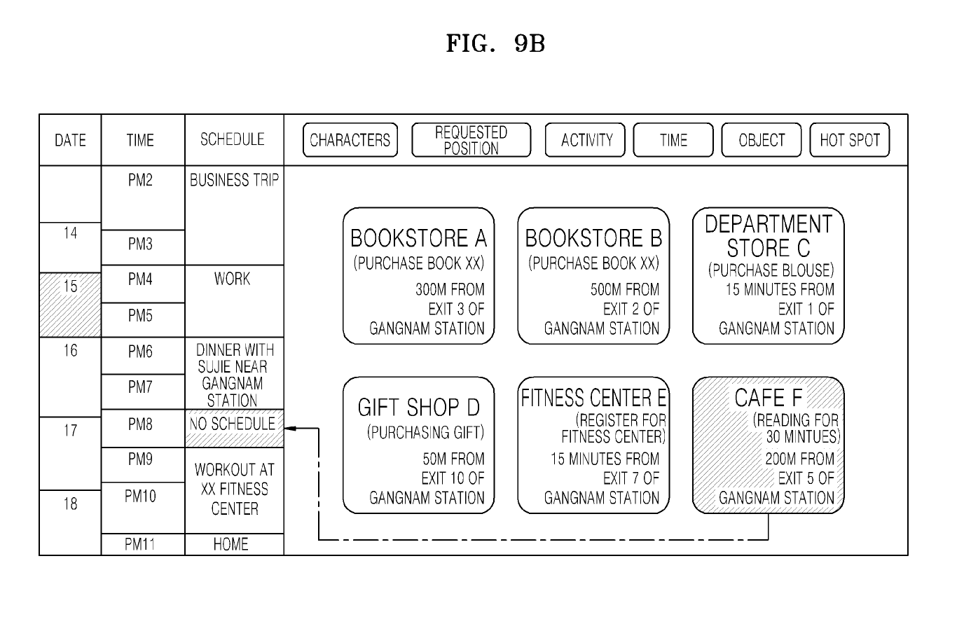

FIGS. 9A and 9B illustrate an exemplary method in which, if a user selects a time at which a schedule event is blank, a to-do that is appropriate for the selected time is selected from a schedule event before or after the selected time and to-do information that is stored in the device 100, and a position is recommended based on the selected to-do, according to an embodiment of the present invention.

The device 100 may select at least one to-do that is appropriate for the selected time, based on a relation between the user's to-do information that is stored in the device 100 and schedule event information of the device 100 regarding the selected time.

The relation between the user's to-do information and schedule event information of the device with regard to the selected time may include a common point and a similar point from among basic information for position recommendation, such as an object, characteristics, an activity, or a position of to-do information and schedule event information.

The device 100 may receive one or more positions, which are searched for based on to-do information and schedule event information, from the position-recommendation apparatus 200.

The device 100 may add a position that is selected by a user and to-do information that relates to the selected position to a schedule event that corresponds to the selected time.

FIG. 9A illustrates to-do information of the user. As illustrated in FIG. 9A, basic information for position recommendation may be extracted from the respective to-dos.

A position may be recommended based on characteristics, an object, or an activity of a to-do, from among basic information for position recommendation that is extracted from the to-do information. For example, a cafe, which is appropriate for reading a book, may be recommended. Otherwise, a department store which is appropriate for purchasing clothes may be recommended, or a bookstore which is appropriate for purchasing a book may be recommended.

A position may be recommended in consideration of basic information for position recommendation, which is extracted from to-do information, and basic information for position recommendation, which is extracted from a schedule event before or after selected time. For example, basic information for position recommendation, which includes “Gangnam Station” as a position, “evening” as time, “friend” as a relationship between a particular person and a user, “social gathering” as an object, and “dinner” as an activity, may be extracted from “dinner with Sujie near Gangnam Station” which is a schedule event before a time that is selected in FIG. 9B. Basic information for position recommendation that includes a hobby, a workout, Gangnam, and 9 pm may be extracted from “xx fitness center in Gangnam” that is a schedule event after the selected time. Accordingly, basic information for position recommendation that is common between schedule events before and after the selected time is Gangnam as a position. Thus, a user is presumed to be in Gangnam before and after the schedule event. Accordingly, a position appropriate for a to-do may be recommended based on a position that is located near Gangnam station. If a position that is extracted from a particular to-do is present on a moving path according to a schedule event, a corresponding to-do may be recommended.

A to-do may be selected by referring to a pattern that matches a user's schedule pattern from the schedule pattern DB. A position relating to the selected to-do may be recommended by referring to a schedule pattern-position relation DB. For example, a schedule event before the selected time, illustrated in 9B, is dinner with a friend, and a schedule event after the selected time is a workout. Thus, a schedule pattern that matches the schedule event is extracted from the schedule pattern DB, and an activity that matches the extracted schedule pattern, from among the to-do information may be selected as a priority. Furthermore, a position that is appropriate for the selected activity may be recommended by extracting a position category that corresponds to a schedule pattern from the schedule pattern-position relation DB.

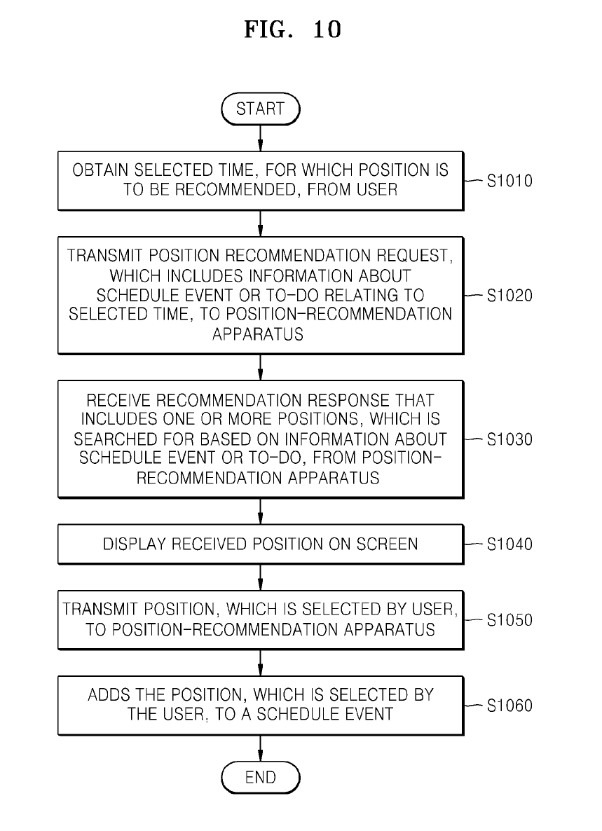

FIG. 10 illustrates an exemplary method in which, if a schedule event is selected, the device 100 receives a recommendation of a position relating to the selected schedule event or to-do information.

In operation S1010, the device 100 obtains selected time, for which a position is to be recommended, from a user. Operation S1010 corresponds to operation S310 illustrated in FIG. 3.

In operation S1020, the device 100 transmits a position recommendation request, which includes schedule event information or to-do information relating to the selected time, to the position-recommendation apparatus 200.

Information about a schedule event or a to-do relating to the selected time refers to, if a schedule event is present at the selected time, the corresponding schedule event or, if a schedule event is not present at the selected time, a schedule event before or after the selected time. The information about a schedule event or a to-do relating to the selected time may include to-do information that is stored in the device 100.

Information about a schedule event or a to-do relating to a selected time, which is transmitted to the position-recommendation apparatus 200, may be a schedule event or a to-do that is stored in the device 100, or basic information for position recommendation that is extracted from the schedule event information or the to-do information.

In operation S1030, the device 100 receives a recommendation response that includes one or more positions, which is searched for based on at least one of the schedule event information and the to-do information, from the position-recommendation apparatus 200. In other words, a position, which is searched for based on basic information for position recommendation such as a position, time, a date, an activity, a relationship between a particular person and a user, a day of a week, an anniversary day, or an object, may be received from the position-recommendation apparatus 200.

In operation S1040, the device 100 displays a position, which is received from the position-recommendation apparatus 200, on a screen.

In operation S1050, the device 100 transmits a position, which is selected by a user, to the position-recommendation apparatus 200. Information about the position, which is transmitted to the position-recommendation apparatus 200, may be information for updating a position statistics DB, a schedule pattern, and a schedule pattern-position relation DB of a particular user or all users.

In operation S1060, the device 100 adds the position, which is selected by the user, to a schedule event. The device 100 may add the position, which is selected by the user, as a position for a schedule event that is selected by the user.

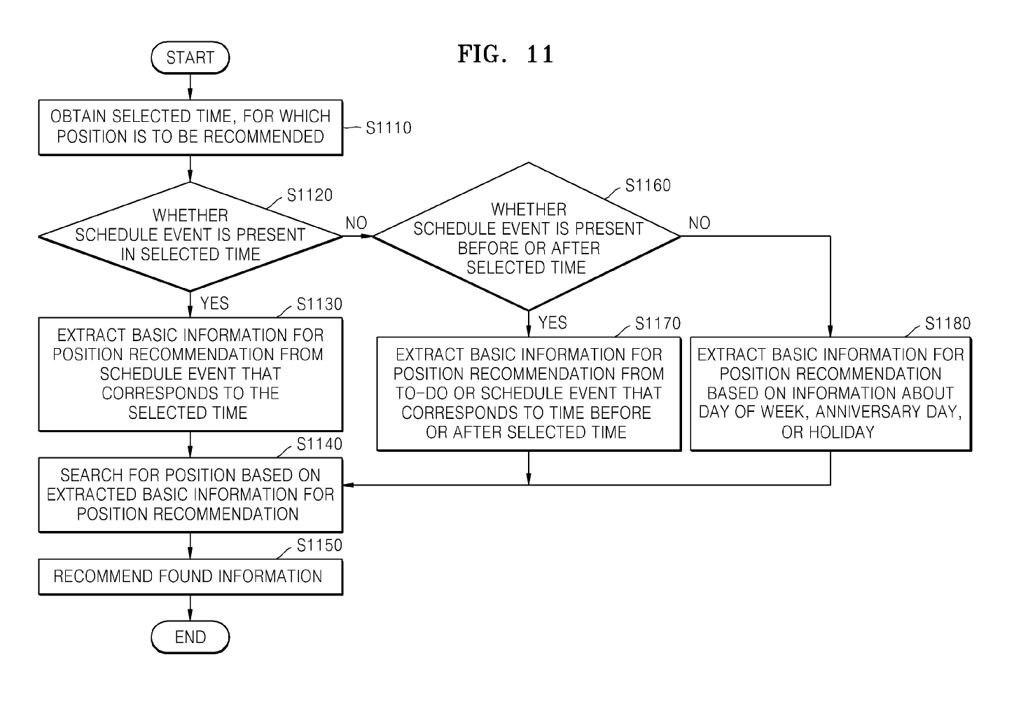

FIG. 11 illustrates an exemplary method, performed by the device, of recommending a position, according to whether a schedule event is present at a time that a user selects.

In operation S1110, a selected time, for which a position is to be recommended, may be obtained by the user.

In operation S1120, whether a schedule event is present at the selected time is determined.

If a schedule event is present at the selected time in operation S1120, basic information for position recommendation is extracted from a schedule event that corresponds to the selected time, in operation S1130.

Otherwise, if a schedule event is not present at the selected time in operation S1120, whether the schedule event is present before or after the selected time is determined in operation S1160.

If the schedule event is present before or after the selected time in operation S1160, basic information for position recommendation is extracted from schedule event information or to-do information that is present before or after the selected time, in operation S1170.

Otherwise, if the schedule event is not present before or after the selected time in operation S1160, basic information for position recommendation is extracted based on information about a day of a week, an anniversary day, or a holiday that corresponds to the selected time, in operation S1180.

A position is searched for based on the basic information for position recommendation that is extracted in operation S1140.

In operation S1150, a found position is recommended to the user.

Information about a schedule event or a to-do may be stored in the device 100, or the position-recommendation apparatus 200. Accordingly, a flowchart of the method, illustrated in FIG. 11, may be executed by the position-recommendation apparatus 200.

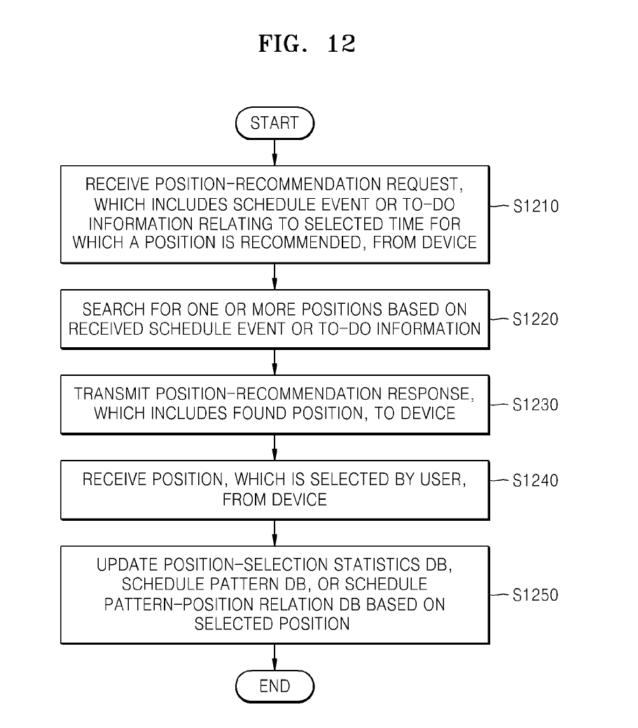

FIG. 12 illustrates an exemplary method, performed by the position recommendation apparatus 200, of recommending a position to the device 100 and receiving information about a position that is selected by the device 100, thus updating a DB.

In operation S1210, a position-recommendation request, which includes schedule event or to-do information relating to a selected time for which a position is recommended, is received from the device 100.

In operation S1220, one or more positions are searched for based on the received schedule event or to-do information.

In operation S1230, a position-recommendation response, which includes a found position, is transmitted to the device 100.

In operation S1240, a position, which is selected by a user, is received from the device 100.

In operation S1250, based on the selected position, a position-selection statistics DB, a schedule pattern DB, or a schedule pattern-position relation DB is updated.

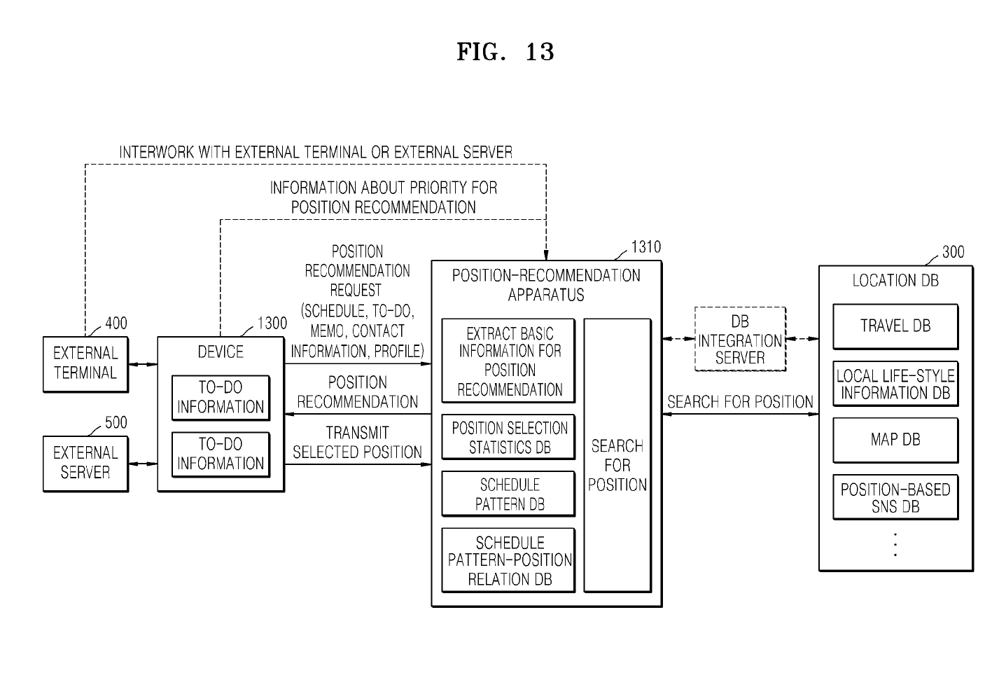

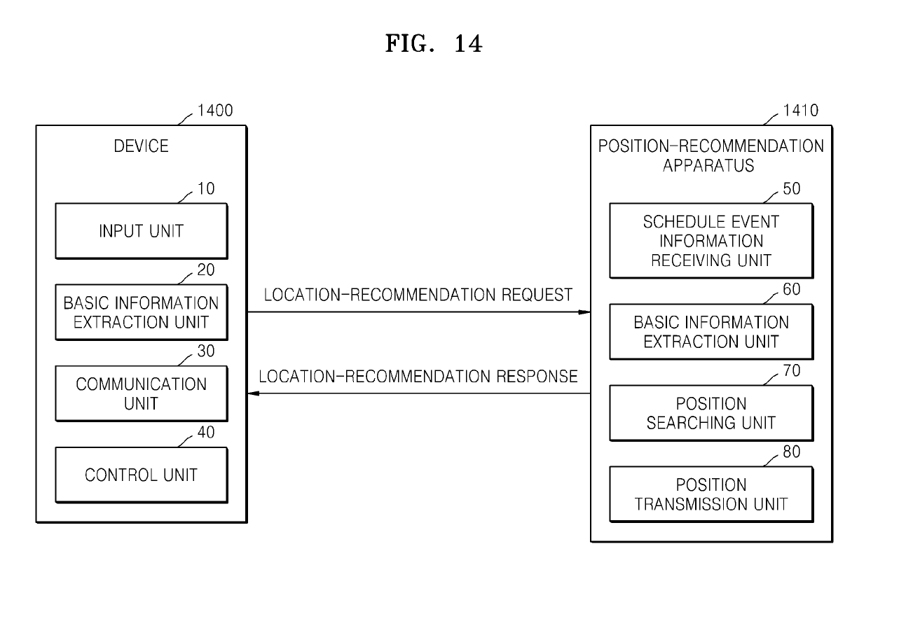

FIG. 13 illustrates a system for recommending a position based on schedule event information or to-do information, according to an embodiment of the present invention.

The device 1300 transmits a position-recommendation request, which includes schedule event information or to-do information, to the position recommendation apparatus 200. The device 1300 may transmit a position-recommendation request, which includes basic information for position recommendation that is extracted from the schedule event information or the to-do information, to the position recommendation apparatus 1310. In addition to the schedule event information or the to-do information, user information such as a memo, contact information, or profile information may be transmitted to the position-recommendation apparatus 1310, and thus used as the basic information for position recommendation.

The device 1300 may receive a recommendation response, which includes a position, from the position-recommendation apparatus 1310 and, if a user selects a position, transmit information about the selected position to the position-recommendation apparatus 1310.

If the user selected a priority for position recommendation, the device 1300 may transmit information about priority items for position recommendation to the position-recommendation apparatus 1310.

The device 1300 may interwork with an external terminal 400 or an external server 500 which stores schedule event or to-do information so as to share the schedule event or to-do information with the external terminal 400 or the external server 500. The device 1300 may share information with the external terminal 400, via a near-field wireless communication such as a wireless local area network (LAN), wireless fidelity (Wi-Fi), Bluetooth, Zigbee, Wi-Fi direct (WFD), ultra wideband (UWB), infrared data association (IrDA), Bluetooth low energy (BLE), or near field communication (NFC).

The device 1300 may share schedule event or to-do information with the external server 500 or a cloud server by interworking with the external server 500 or the cloud server via a wired or wireless communication.

The position-recommendation apparatus 1310 receives a position-recommendation request, which includes schedule event information or to-do information, from the device 1300. The position-recommendation request may include user information such as a memo, contact information, or profile information, as well as schedule event information or to-do information. The position-recommendation apparatus 1310 may search for a position based on the received schedule event or to-do information. The position-recommendation apparatus 1310 may extract basic information for position recommendation from the received schedule event or to-do information, and search for a position based on the extracted basic information for position recommendation. The position-recommendation apparatus 1310 may receive information about priority items for position recommendation and search for a position based on the received information about the priority items for position recommendation.

The position-recommendation apparatus 1310 may extract a position from a position DB 300, based on the basic information for position recommendation. The position DB stores information about a position. The position DB may include a travel DB, a local life-style information DB, a map DB, or a position-based social network service (SNS) DB, but is not limited thereto. The position DB may be located in an external network that is separate from the position-recommendation apparatus 1310, and may be plural. The position-recommendation apparatus 1310 may be directly connected to a plurality of the position DBs 300 or connected to an integration server, in which a plurality of the position DBs 300 are integrated, so as to extract a position via the integration server.

The position-recommendation apparatus 1310 may transmit a found position to the device 1300. The position-recommendation apparatus 1310 may receive a position that is selected by a user. The position-recommendation apparatus 1310 may update a position-selection statistics DB, a schedule pattern DB, and a schedule pattern-position relation DB by using the position that is selected by the user.

The position-recommendation apparatus 1310 may receive schedule event or to-do information of the user of the device 1300 from the external terminal 400 or the external server 500. Even if there is no position-recommendation request from the user, the position-recommendation apparatus 1310 may receive schedule event or to-do information of the user from the external terminal 400 or the external server 500 and recommend a position relating to the schedule event or to-do information to the user.

FIG. 14 illustrates device 1400 and the position recommendation apparatus 1410 for recommending a position based on schedule event information or to-do information, according to an embodiment of the present invention.

The device 1400 may include an input unit 10, a basic information extraction unit 20, a communication unit 30, and a control unit 40.

The input unit 10 may receive an input of a schedule event, a to-do, or a selected time, for which a position is to be recommended, from a user. The device 1400 may receive an input of a time directly from a user, or via an external device that is wire and/or wirelessly connected to the device 1400. The input unit 10 may receive an input of a position that is selected by a user. The input unit 10 may include a keyboard, a mouse, a trackball, a voice recognition unit, a gesture recognition unit, an iris recognition unit, a touch screen, or other various input apparatuses that may be obvious to one of ordinary skill in the art.

The basic information extraction unit 20 may extract basic information for position recommendation from schedule event or to-do information relating to a time that is selected by a user.

The communication unit 30 may transmit a position-recommendation request, which includes the extracted basic information for position recommendation, to the position-recommendation apparatus 1410. The communication unit 30 may receive a position-recommendation response, which includes one or more positions that are searched for based on the basic information for position recommendation, from the position-recommendation apparatus 1410.

The control unit 40 may add a position, which is selected by a user, to a schedule event that corresponds to the selected time.

The basic information for position recommendation may include at least one of a relationship between a particular person and a user, a time, a day of a week, a date, a position, a location, an object or characteristics of the schedule event, or an activity of the schedule event.

The position-recommendation apparatus 1410 may include a schedule event information receiving unit 50, a basic information extraction unit 60, a position searching unit 70, and a position transmission unit 80.

The schedule event information receiving unit 50 may receive a position-recommendation request, which includes schedule event information relating to a selected time for which a position is to be recommended, from the device 1400.

The basic information extraction unit 60 may extract basic information for position recommendation from a schedule.

The position searching unit 70 may search for one or more positions based on the basic information for position recommendation.

The position transmission unit 80 may transmit a position-recommendation response, which includes a found position, to the device 100.

An exemplary embodiment of the present invention may be implemented through computer-readable code/instructions in/on a medium, e.g., a computer-readable medium, to control at least one processing element to implement any above-described embodiment. The medium may correspond to any medium/media permitting the storage and/or transmission of the computer-readable code.

The computer-readable code may be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to an exemplary embodiment of the present invention. The media may be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While exemplary embodiments of the present invention have been described with reference to the figures, it will be understood by those of ordinary skill in the art that various changes in form and details may be made therein without departing from the spirit and scope of the present invention as defined by the following claims.

What is claimed is:

1. A method, performed by a device, of receiving a recommendation of a position from a position-recommendation apparatus, the method comprising:
obtaining a selected time, for which a position is to be recommended, from a user;
transmitting a position-recommendation request, which comprises schedule event information relating to the selected time, to the position-recommendation apparatus; and
receiving a response to the position-recommendation request, which comprises one or more positions that are searched for based on the schedule event information, from the position-recommendation apparatus.

2. The method of claim 1, wherein the transmitting of the position-recommendation request, which comprises the schedule event information relating to the selected time, to the position-recommendation apparatus further comprises:
extracting basic information for position recommendation from the schedule event information, and
transmitting a position-recommendation request, which comprises the basic information for position recommendation, to the position-recommendation apparatus.

3. The method of claim 2, wherein the basic information for position recommendation comprises at least one from among a relationship between a particular person and a user, a time, a day of a week, a date, a position, a location, or an object, characteristics, or an activity of the schedule event.

4. The method of claim 3, wherein the object, the characteristics, or the activity of the schedule event is extracted by referring to information about a user profile, and
the relationship between the particular person and the user is extracted by referring to information about contact information.

5. The method of claim 1, wherein the schedule event information relating to the selected time is schedule event information that corresponds to the selected time.

6. The method of claim 1, further comprising adding a position, which is selected by the user, to a schedule event which corresponds to the selected time.

7. The method of claim 1, further comprising transmitting the position, which is selected by the user, to the position-recommendation apparatus.

8. The method of claim 1, further comprising transmitting a priority item, which is to be regarded as a priority for position recommendation, to the position-recommendation apparatus,
wherein one or more found positions are one or more positions that are searched for based on the schedule event information and the priority item.

9. The method of claim 1, wherein the schedule event information of the device, relating to the selected time, is schedule event information that corresponds to a schedule event before or after the selected time.

10. The method of claim 9, wherein the method of receiving the recommendation further comprises selecting at least one to-do for the selected time, based on a relationship between to-do information of the user, which is stored in the device, and schedule event information of the device, which relates to the selected time,
wherein the position-recommendation request further comprises the to-do information, and
the receiving of the one or more positions, which are searched for based on the schedule event information, from the position-recommendation apparatus further comprises receiving one or more positions, which are searched for based on the to-do information and the schedule event information, from the position-recommendation apparatus.

11. The method of claim 9, further comprising adding a position, which is selected by the user, and to-do information, which relates to the selected position, to a schedule event that corresponds to the selected time.

12. A method, performed by a position-recommendation apparatus, of recommending a position to a device, the method comprising:
receiving a position-recommendation request, which comprises schedule event information relating to a selected time for which a position is to be recommended to a user, from the device;
searching for one or more positions based on the schedule event information; and
transmitting a response to the position-recommendation request, which comprises one or more found positions, to the device.

13. The method of claim 12, wherein the searching for one or more positions based on the schedule event information further comprises:
extracting basic information for position recommendation from the schedule event information, and
searching for one or more positions based on the basic information for position recommendation.

14. The method of claim 13, wherein the basic information for position recommendation comprises at least one from among a relationship between a particular person and a user, a time, a day of a week, a date, a position, a location, or an object, characteristics, or an activity of the schedule event.

15. The method of claim 14, wherein the object, the characteristics, or the activity of the schedule event are extracted by referring to information about a user profile, and
the relationship between the particular person and the user is extracted by referring to information about a contact information.

16. The method of claim 12, wherein the searching for of the one or more positions based on the schedule event information is performed by searching for one or more positions based on schedule event information that corresponds to a selected time for which a position is to be recommended.

17. The method of claim 12, further comprising receiving a priority item, which is to be regarded as a priority for position recommendation, from the device,
wherein the searching for one or more positions for the selected time based on the schedule event information is performed by searching for the position by prioritizing the priority item.

18. The method of claim 12, further comprising:
receiving a position, selected by a user, from the device; and
updating a database for position-selection statistical information, by using the selected position.

19. The method of claim 12, wherein the searching for one or more positions based on the schedule event information is performed by searching for one or more positions by further considering the position-selection statistical information.

20. The method of claim 12, wherein the searching for one or more positions based on the schedule event information is performed by searching for one or more positions based on schedule event information that corresponds to a schedule event before or after a selected time for which a position is to be recommended.

21. The method of claim 20, further comprising:
receiving to-do information of the user from the device; and
based on a relationship between to-do information of the user and schedule event information that corresponds a schedule event before or after the selected time, deducting at least one to-do for the selected time,
wherein the searching for one or more positions based on the schedule event information further comprises searching for one or more positions based on the deduced to-do and the schedule event information.

22. A device for receiving a recommendation from a position-recommendation apparatus, the device comprising:
an input unit for receiving an input of a selected time for which a position is to be recommended;
a basic information extraction unit for extracting basic information for position recommendation from schedule event information relating to the selected time; and
a communication unit for transmitting a position-recommendation request, which comprises the extracted basic information for position recommendation, to the position-recommendation apparatus, and receiving a response to the position-recommendation request, which comprises one or more positions that are searched for based on the basic information for position recommendation, from the position-recommendation apparatus.

23. The device of claim 22, wherein the basic information for position recommendation comprises at least one from among a relationship between a particular person and a user, a time, a day of a week, a date, a position, a location, or an object, characteristics, or an activity of the schedule event.

24. The device of claim 22, wherein the input unit further comprises receiving an input of a position that is selected by the user, and
wherein the device further comprises a control unit for adding the selected position to a schedule event that corresponds to the selected time.

25. A position-recommendation apparatus for recommending a position to a device, the position-recommendation apparatus comprising:
a schedule event information receiving unit for receiving a position-recommendation request, which comprises schedule event information relating to a selected time for which a position is to be recommended, from the device;
a basic information extraction unit for extracting basic information for position recommendation from the schedule event information;
a position searching unit for searching for one or more positions based on the basic information for position recommendation; and
a position transmitting unit for transmitting a response to the position-recommendation request, which comprises a found position, to the device.

26. The position-recommendation apparatus of claim 25, wherein the basic information for position recommendation comprises at least one from among a relationship between a particular person and a user, a time, a day of a week, a date, a position, a location, or an object, characteristics, or an activity of the schedule event.

27. A non-transitory computer-readable recording medium having stored thereon a computer program, which when executed by a computer, performs the method of claim 1.

28. A method performed by a device of obtaining a recommendation of a first information from an apparatus, the method comprising:
obtaining a second information related to the first information from a user;
transmitting a request including a schedule event information relating to the selected second information to the apparatus; and
receiving a response to the request, which comprises one or more values that are searched for based on the schedule event information, from the apparatus.

29. The method of claim 28, wherein the first information includes a position.

30. The method of claim 28, wherein the second information includes a time.

31. A method performed by an apparatus of recommending a first information to a device, the method comprising:
receiving a request, which comprises schedule event information relating to a second information for which the first information is to be recommended to a user, from the device;
searching for one or more first information based on the schedule event information; and
transmitting a response to the request, which comprises one or more found first information, to the device.

32. The method of claim 31, wherein the first information includes a position.

33. The method of claim 31, wherein the second information includes a time.
